(19) United States
(12) Patent Application Publication
(10) Pub. No.: US 2009/0231637 A1
(43) Pub. Date: Sep. 17, 2009

(54) SYSTEM AND METHOD FOR SCANNING/ACCUMULATING IMAGE, AND COMPUTER PROGRAM PRODUCT

(75) Inventors: Eiji KEMMOCHI, Tokyo (JP); Masashi Nakatomi, Kanagawa (JP); Soichiro Iga, Tokyo (JP); Tetsuro Nagatsuka, Tokyo (JP); Nahoko Sato, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD, Tokyo (JP)

(21) Appl. No.: 12/402,968

(22) Filed: Mar. 12, 2009

(30) Foreign Application Priority Data
Mar. 13, 2008 (JP) 2008-064866
Feb. 2, 2009 (JP) 2009-021759

(51) Int. Cl. H04N 1/04

(52) U.S. Cl. 358/474

(57) ABSTRACT

An image scanning/accumulating system including an information issuing unit that acquires image data; and an information managing unit that includes an image-data database for storing therein the image data acquired by the information issuing unit, and manages the image data. The information managing unit includes a task-information database, and manages task information stored in the task-information database. The information issuing unit includes an image pickup unit that scans a paper-based document thereby obtaining image data, and registers the image data in the image-data database; an information display unit that acquires task information from the task-information database to be associated with the image data obtained by the image pickup unit, and displays acquired task information on a task-information setting screen; and a notifying unit that notifies a contact address included in the task information that the image data associated with the task information is registered in the image-data database.

### CROSS-REFERENCE TO RELATED APPLICATIONS

The present application claims priority to and incorporates by reference the entire contents of Japanese priority document 2008-064866 filed in Japan on Mar. 13, 2008 and Japanese priority document 2009-021759 filed in Japan on Feb. 2, 2009.

### BACKGROUND OF THE INVENTION

1. Field of the Invention

The present invention relates to a technology for scanning a paper-based document and accumulating electronic image data on the scanned document.

2. Description of the Related Art

In recent years, a personal computer (PC) connected to a printer and a scanner as peripheral devices and a digital multifunction product (MFP) including a printer function, a scanner function, a network function, and the like have been in widespread use. The PC or the MFP stores/accumulates image data obtained with the scanner (the scanner function) in a hard disk drive (HDD) built into a main body thereof in an electronic file format, and later on, for example, prints out the image data or sends the image data as an attachment to an e-mail by reading out the image data from the HDD.

When image data is stored/accumulated in such an apparatus, as additional information, a user name, date and time when the image data was originally stored/accumulated, a document name, and the like, are generally added to the image data by a user. Namely, each time image data is stored/accumulated, burden is put on a user of inputting such additional information to the image data.

To avoid such a cumbersome operation, in a technology disclosed in Japanese Patent Application Laid-open No. 2005-100196, based on a shooting date printed on a photo, image data on the photo is associated with schedule for the date so as to search the image data by the schedule later on.

Furthermore, in a technology disclosed in Japanese Patent Application Laid-open No. 2007-066065 (U.S. application Ser. No. 11/512,294) by the present applicant, when image data on a captured paper-based document is accumulated, the image data is associated with user schedule information (a title text, date and time when the image data is posted, and a posting time). Therefore, it is possible to lighten the burden of manual entry of information on a user.

Moreover, image data captured/accumulated by a user may be useful information not only to the user but also to others, especially others associated with the user, such as participants of a project that the user is involved in.

There is a need of a technology that can accumulate additional information in association with image data as well as inform others of accumulation of such image data.

### SUMMARY OF THE INVENTION

It is an object of the present invention to at least partially solve the problems in the conventional technology.

According to an aspect of the present invention, there is provided an image scanning/accumulating system including an information issuing unit that acquires image data; and an information managing unit that includes an image-data database for storing therein the image data acquired by the information issuing unit, and manages the image data. The information managing unit includes a task-information database, and manages task information stored in the task-information database. The information issuing unit includes an image pickup unit that scans a paper-based document thereby obtaining image data, and registers the image data in the image-data database; an information display unit that acquires task information from the task-information database to be associated with the image data obtained by the image pickup unit, and displays acquired task information on a task-information setting screen; and a notifying unit that notifies a contact address included in the task information that the image data associated with the task information is registered in the image-data database.

According to another aspect of the present invention, there is provided an image scanning/accumulating method implemented in an image scanning/accumulating system that includes an information issuing unit that includes an image pickup unit capable of scanning a paper-based document thereby obtaining image data; and an information managing unit that includes an image-data database for storing therein the image data acquired by the information issuing unit and manages the image data, and a task-information database, and manages task information stored in the task-information database. The image scanning/accumulating method including the information issuing unit acquiring task information from the task-information database to be associated with the image data obtained by the image pickup unit, and displaying acquired task information on a task-information setting screen on an information display unit; the information issuing unit causing the image pickup unit to scan a paper-based document thereby obtaining image data, and registering the image data in the image-data database of the information managing unit; and a notifying unit of the information issuing unit notifying a contact address included in the task information that the image data associated with the task information is registered in the image-data database.

According to still another aspect of the present invention, there is provided a computer program product that includes a computer program stored on a computer-readable recording medium which when executed on a computer causes the computer to realize the above image scanning/accumulating method implemented in an image scanning/accumulating system.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1D are schematic diagrams illustrating examples of a hardware configuration of an image scanning/accumulating system according to the present invention;

FIG. 2 is a functional block diagram of the image scanning/accumulating system having the hardware configuration shown in FIG. 1A;

FIG. 3 is an explanatory diagram of a user selection screen displayed on a touch panel;

FIG. 4 is a flowchart of a process for displaying the user selection screen;

FIG. 5 depicts an example of an acquired user information list;

FIG. 6 depicts an example of a created per-page user information list;

FIG. 7 is a flowchart of a process executed when a “NEXT” button shown in FIG. 3 is touched;

FIG. 8 is a flowchart of a process executed when a “PREVIOUS” button shown in FIG. 3 is touched;

FIG. 9 is a flowchart of a process executed when a user-name button is touched;

FIG. 10 is a flowchart of a process executed when a “NAME ENTRY” button is touched;

FIG. 11 is an explanatory diagram of a software keyboard;

FIG. 12 is a flowchart of a process for password authentication;

FIG. 13 is an explanatory diagram of the software keyboard;

FIG. 14 is an explanatory diagram of an example of a task-information selection screen;

FIG. 15 is a flowchart of a process for displaying the task-information selection screen;

FIG. 16 depicts an example of an acquired task information list;

FIG. 17 is an explanatory diagram of an example of a created per-page task information list;

FIG. 18 is a flowchart of a process executed when a “NEXT PAGE” button is touched;

FIG. 19 is a flowchart of a process executed when a “PREVIOUS PAGE” button is touched;

FIG. 20 is a flowchart of a process executed when a task selection button is touched;

FIG. 21 is a flowchart of a process executed when a “DETAIL” button is touched;

FIG. 22 is an explanatory diagram of an example of a dialog window displaying thereon detail information;

FIG. 23 is a flowchart of a process executed when a “SETTING” button shown in FIG. 14 is touched;

FIG. 24 is an explanatory diagram of an example of a created selected task information list;

FIG. 25 is an explanatory diagram of an example of a parameter setting screen displayed on the touch panel;

FIG. 26 is a flowchart of a process for displaying the parameter setting screen;

FIG. 27 depicts an example of a created notifying user list;

FIG. 28 is depicts an example of a created image data list;

FIG. 29 is depicts an example of a created scan setting list;

FIG. 30 is a flowchart of a process executed when a scan setting button is touched;

FIG. 31 is a flowchart of a process executed when a scope-of-disclosure setting button is touched;

FIG. 32 depicts an example of an acquired image-data reference list;

FIG. 33 depicts an example of an association information list of association information between image data and selected task information;

FIG. 34 depicts an example of a content of an e-mail;

FIG. 35 depicts an example of the content of the e-mail that items are replaced by values;

FIG. 36 is an explanatory diagram of an example of a parameter setting screen used in a second embodiment of the present invention;

FIG. 37 is a flowchart of a process for displaying the parameter setting screen shown in FIG. 36;

FIG. 38 is a flowchart of a process executed when a notifying user button is touched;

FIG. 39 is a functional block diagram of the image scanning/accumulating system having the hardware configuration shown in FIG. 1B;

FIG. 40 is an exemplary functional block diagram of the image scanning/accumulating system having the hardware configuration shown in FIG. 1C; and

FIG. 41 is an exemplary functional block diagram of the image scanning/accumulating system having the hardware configuration shown in FIG. 1D.

### DETAILED DESCRIPTION OF THE PREFERRED EMBODIMENTS

Exemplary embodiments of the present invention are explained in detail below with reference to the accompanying drawings.

First, terms used in the embodiments are explained below.

The term “task information” includes project information, schedule information, to-do information, and user group information.

Specifically, the project information includes a name of a project, a purpose of the project, a place where the project is implemented, members of the project, equipment used in the project, an implementation term of the project, and the like.

The schedule information includes a name of a scheduled task, a purpose of the scheduled task, a place where the scheduled task is performed, equipment used for performing the scheduled task, a person who performs the scheduled task, date and time when the scheduled task is performed, and the like.

The to-do information includes a name of a task to do (hereinafter, “a to-do task”), a purpose of the to-do task, a place where the to-do task is performed, equipment used for performing the to-do task, a person who performs the to-do task, a term taken for performing the to-do task, and the like.

The user group information includes a name of a user group, a purpose of the user group, a place to which the user group belongs, equipment belonging to the user group, members of the user group, a term taken for performing a task by the user group, and the like.

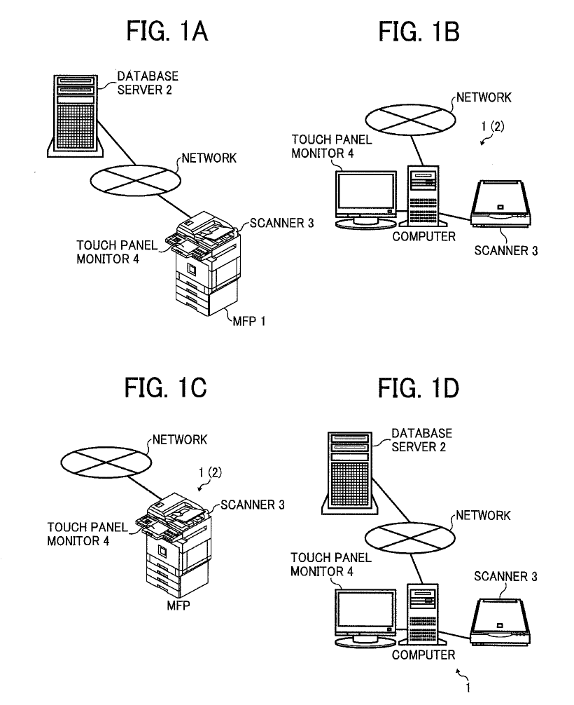

FIGS. 1A to 1D are schematic diagrams illustrating examples of a hardware configuration of an image scanning/accumulating system according to the present invention.

The image scanning/accumulating system according to the embodiments includes an information managing unit and an information issuing unit. The information managing unit stores therein task information (schedule information, project information, to-do information, and user group information) as described above, image data, and the like. The information issuing unit acquires the task information from the information managing unit. Furthermore, the information issuing unit scans a paper-based document with an image capture unit, and associates electronic image data on the scanned document with task information selected by a user. Moreover, the information issuing unit registers information on the association between the image data and the task information in the information managing unit. In addition, the information issuing unit sends a mail to a user associated with the selected task information to inform the user of a name of the user who scans the document, the selected task information, and the like.

FIG. 1A depicts a typical hardware configuration of an image scanning/accumulating system according to an embodiment. In the example shown in FIG. 1A, an MFP, including a scanner 3 and a touch panel monitor (hereinafter, “a touch panel”) 4, and a database server are connected to each other via a network (NW). The MFP serves as an information issuing unit 1, and the database server serves as an information managing unit 2. Incidentally, the information issuing unit 1 is not limited to the MFP. Any apparatus including the scanner 3 and the touch panel 4 can be used as the information issuing unit 1.

Furthermore, in the example shown in FIG. 1B, a computer connected to the network NW is connected to the scanner 3 and the touch panel 4. In this example, the computer serves as both the information issuing unit 1 and the information managing unit 2.

Moreover, in the example shown in FIG. 1C, the MFP, including the scanner 3 and the touch panel 4, is connected to the network NW. In this example, the MFP serves as both the information issuing unit 1 and the information managing unit 2.

In addition, in the example shown in FIG. 1D, the computer connected to the scanner 3 and the touch panel 4 and the database server are connected to each other via the network NW. In this example, the computer serves as the information issuing unit 1, and the database server serves as the information managing unit 2.

Subsequently, a functional configuration of the image scanning/accumulating system according to the present invention is explained in detail below.

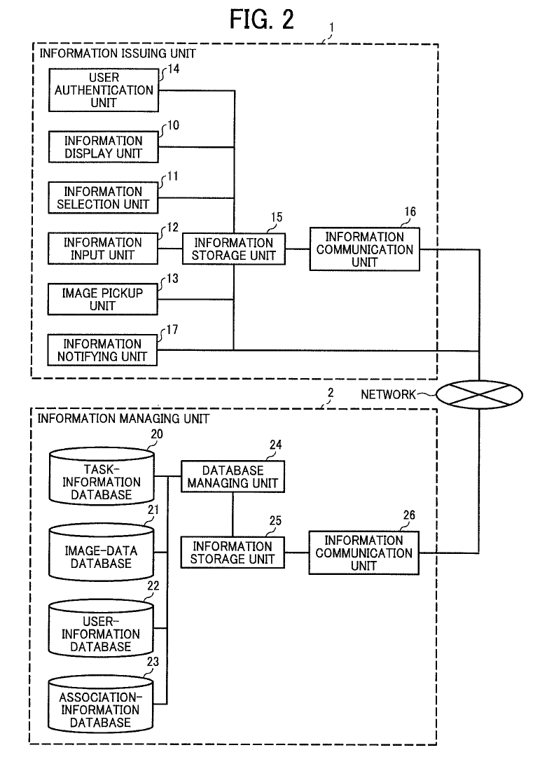

FIG. 2 is an exemplary functional block diagram of the image scanning/accumulating system having the hardware configuration shown in FIG. 1A.

The information issuing unit 1 (corresponding to the MFP) includes an information display unit 10 (corresponding to the touch panel 4), an information selection unit 11, an information input unit 12 (corresponding to the touch panel 4), an image pickup unit 13 (corresponding to the scanner 3), a user authentication unit 14, an information storage unit 15, an information communication unit 16, and an information notifying unit 17. On the information display unit 10, various setting screens and buttons for receiving user's operations are displayed. The information selection unit 11 is buttons displayed on the information display unit 10, and a user select, via the information selection unit 11, a scan setting, a task associated with image data, scope of disclosure of the image data, a user to be notified that the image data is registered in the information managing unit 2 in association with task information, identification data (ID) of a user (hereinafter, “a user ID”) who uses the system, and the like. The information input unit 12 receives an input of necessary information by a user. The image pickup unit 13 scans a paper-based document as image data in accordance with the scan setting information acquired by the information selection unit 11. The user authentication unit 14 acquires password information from user information based on the input user ID, and verifies whether a password input by a user matches the one included in the acquired password information. The information storage unit 15 stores therein scan setting information, task information, scope-of-disclosure information, notifying user information, user IDs, password information, image data, and the like. The information communication unit 16 transmits information stored in the information storage unit 15 to the information managing unit 2 via the network NW, and also receives information from the information managing unit 2 via the network NW. The information notifying unit 17 delivers a mail to a user associated to a selected task, and thereby notifying the user of contents of the mail, such as a name of a user who scans a document and information on the selected task.

Incidentally, the user authentication unit 14 and the information notifying unit 17 are computer programs executed by a central processing unit (CPU) (not shown) included in the information issuing unit 1. A process for controlling the image pickup unit 13 and a process for causing the information display unit 10 to display the information selection unit 11 or the information input unit 12 can be built into a computer program executed by the CPU.

Such a computer program is stored in a portable recording medium such as a compact disc (CD), and the recording medium is installed on a user's computer, so that the computer can be used as the information issuing unit 1.

The information managing unit 2 (corresponding to the database server) includes a task-information database 20, an image-data database 21, a user-information database 22, an association-information database 23, a database managing unit 24, an information storage unit 25, and an information communication unit 26. In the task-information database 20, pieces of task information are accumulated. The task information is specifically schedule information including a name of a meeting or an event, date and time when the meeting or the event is held, participants, and the like, or to-do information including a name of a job to be implemented, an implementation period of the job, and the like. In the image-data database 21, pieces of image data generated in the information issuing unit 1 are accumulated. In the user-information database 22, pieces of “user information” are accumulated. The “user information” includes scope-of-disclosure information indicating whom image data is disclosed, a name of a user, a division to which the user belongs, a mail address, a user ID, an authentication password, and the like. In the association-information database 23, information about an association between task information and image data those generated in the information issuing unit 1 is accumulated. The database managing unit 24 manages the task-information database 20, the image-data database 21, the user-information database 22, and the association-information database 23.

The information communication unit 26 transmits information stored in the information storage unit 25 to the information issuing unit 1 via the network NW, and also receives information from the information issuing unit 1 via the network NW.

Furthermore, a web server (not shown) is provided to each of the databases included in the information managing unit 2, so that a user can perform data acquisition from each of the databases, data entry in each of the databases, update of data stored in each of the databases, deletion of data stored in each of the databases, and the like by accessing a web service on a predetermined Uniform Resource Locator (URL).

For example, by accessing a resource corresponding to the user-information database 22 with a URL, e.g., [http://www.xxx.co.jp/WebService/User] with the HyperText Transfer Protocol (HTTP) GET method, a user can acquire data registered in the user-information database 22.

Furthermore, by accessing the resource with the POST method together with user information in a predetermined format, the user can register data in the user-information database 22. Moreover, by accessing the resource with the PUT method together with user information in a predetermined format, the user can update corresponding data stored in the user-information database 22 based on the transmitted user information. In addition, by accessing the resource with the DELETE method together with a user ID, the user can delete corresponding data stored in the user-information database 22.

Furthermore, the password information on users' passwords is stored in the user-information database 22. From a viewpoint of security, it is assumed that a user can perform acquisition, entry, update, and deletion of a password by accessing a resource with a URL [https://www.xxx.co.jp/WebService/UserPassword] with any of the above HTTP methods.

Moreover, in the same manner as the access to the user-information database 22, a user can perform acquisition, entry, update, and deletion of data stored in the task-information database 20, the image-data database 21, and the association-information database 23 by accessing resources with URLs [http://www.xxx.co.jp/WebService/Task], [http://www.xxx.co.jp/WebService/ImageData], and [http://www.xxx.co.jp/WebService/RelativeInformation], respectively.

Incidentally, the web service as described above can use Ruby as a programming language, Apache as an HTTP server, MySQL or the like as a database system.

Subsequently, a process performed in an image scanning/accumulating system according to a first embodiment of the present invention is briefly explained below. The process is composed of the first to seventh steps as follows.

As the first step of the process, identification of a user is performed. A user needs to touch a button labeled his/her own name on a display screen of the touch panel or directly input the name.

As the second step of the process, authentication of the user is performed. In accordance with an instruction for entry of user authentication information on the display screen, the user enters his/her password. Upon completion of the password entry, the user authentication unit 14 verifies whether the entered password matches the password information stored in the user-information database 22.

As the third step of the process, an associated task is selected. Upon completion of the authentication of the user, the information issuing unit 1 acquires task information including a user ID from the task-information database 20, and displays the task information associated with the user on the display screen. The user selects at least one task from the displayed task information.

As the fourth step of the process, scanning parameters are set, and a scan job is executed. The user sets scan setting information and the scope of disclosure. Upon completion of the settings, the user puts a paper-based document to be scanned at a predetermined position on the MFP, and touches a “SCAN” button thereby causing the MFP to start scanning the document.

As the fifth step of the process, image data on the scanned document is registered, and reference information is acquired. When the scan job is started, the image pickup unit 13 stores captured image data in accordance with the scan settings. Upon completion of the scan job, the information issuing unit 1 registers the stored image data and information on the scope of disclosure in the image-data database 21, and acquires reference information of the registered information.

As the sixth step of the process, association information is registered. The information issuing unit 1 registers selected task information or reference information of the selected task information and the registered image data or reference information of the registered image data in the association-information database 23 in pairs.

As the seventh step of the process, the information notifying unit 17 notifies a user associated with the image data of information. For example, the information notifying unit 17 sends an e-mail to a user whose e-mail address is listed on a selected notifying user list to notify the user of at least a name of the user who executes the scan job, the selected task information, and the reference information of the stored image data.

Subsequently, each of the above first to seventh steps of the process is explained in detail.

[First Step: User Identification]

First, a user who uses the system is identified.

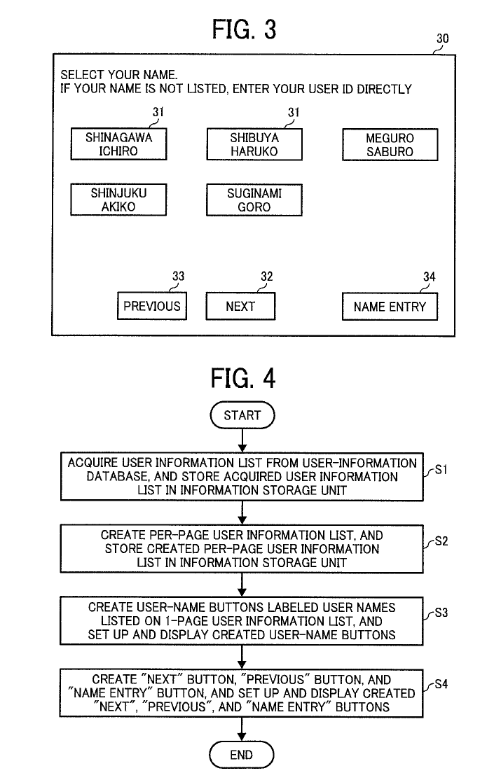

FIG. 3 is a schematic diagram of a user selection screen 30 displayed on the touch panel 4 as the information display unit 10.

Oh the user selection screen 30 (as a user-information selection screen) shown in FIG. 3, user-name buttons 31 labeled users' names respectively as the information selection unit 11, a “NEXT” button 32 for displaying other user-name buttons 31 on a next page, a “PREVIOUS” button 33 for displaying other user-name buttons 31 on a previous page, and a “NAME ENTRY” button 34 for entering a user name directly by a user are displayed.

A user touches the one labeled his/her own name out of the user-name buttons 31 displayed on the user selection screen 30. For example, when the user is Shinagawa Ichiro, the user touches the top-left user-name button 31 labeled “SHINAGAWA ICHIRO”.

If the user-name button 31 labeled his/her own name is not displayed on the user selection screen 30, the user touches the “NEXT” button 32 or the “PREVIOUS” button 33 thereby switching the display screen to display other user-name buttons 31.

When the user touches the “NAME ENTRY” button 34, a software keyboard to be described later is displayed on the touch panel 4, so that the user can directly enter the user name.

A process for displaying the user selection screen 30 on the touch panel 4 performed by the information issuing unit 1 is explained below with reference to FIG. 4. FIG. 4 is a flowchart of the process for displaying the user selection screen 30 on the touch panel 4.

The information issuing unit 1 accesses a resource [http://www.xxx.co.jp/WebService/User] with the GET method via the information communication unit 16, acquires a user information list from the user-information database 22, and stores the acquired user information list in the information storage unit 15 (Step S1).

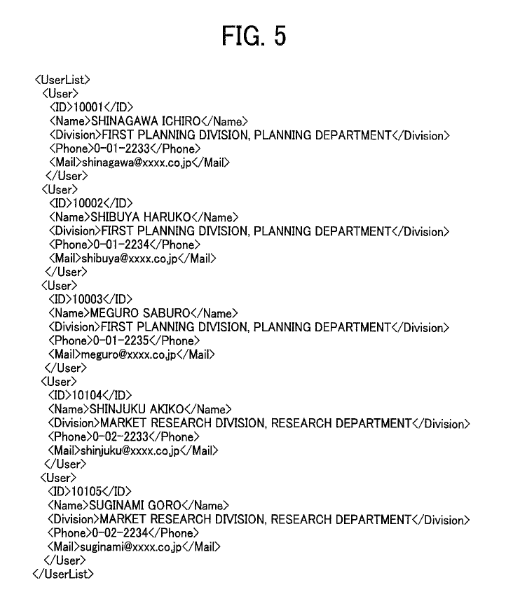

FIG. 5 is an explanatory diagram of an example of the acquired user information list. In the example shown in FIG. 5, the user information list is described in an Extensible Markup Language (XML) format. Each of <User> tags includes individual user information.

In each of the user information, an <ID> tag includes a user ID, a <Name> tag includes a user name, a <Division> tag includes a division to which the user belongs, a <Phone> tag includes a phone number, and a <Mail> tag includes a mail address.

For example, when the user is Shinagawa Ichiro, his user information is described in a <User> tag including a <Name> tag including a value of “SHINAGAWA ICHIRO”. The user information shows that his user ID is 10001, a division to which he belongs is the first planning division in the planning department, his phone number is 0-01-2233, and his mail address is shinagawa@xxxx.co.jp.

Incidentally, data in the user-information database 22 does not always have to be stored in the XML format as shown in FIG. 5. Furthermore, components of user information are not limited to those shown in FIG. 5.

To return to the explanation of the flowchart shown in FIG. 4, the information issuing unit 1 creates a per-page user information list from the acquired user information list because the user-name buttons 31 are displayed over a plurality of pages due to space limitation of the display screen, and stores the created per-page user information list in the information storage unit 15 (Step S2).

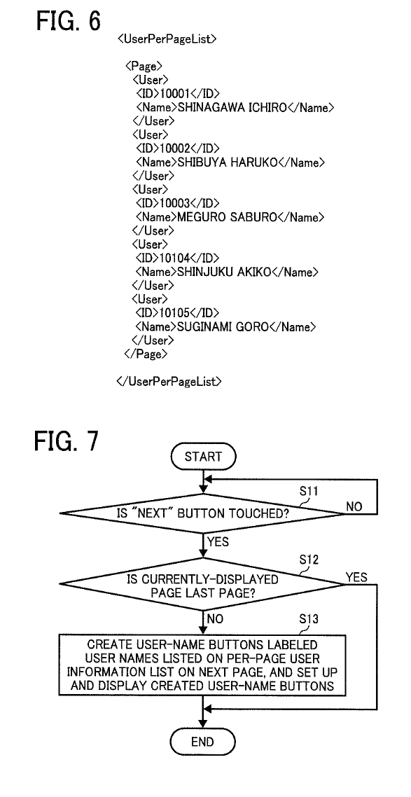

FIG. 6 is an explanatory diagram of an example of the created per-page user information list. As shown in FIG. 6, the per-page user information list is, in the same manner as the user information list, described in an XML format. A <Page> tag includes pieces of user information included in each page, a <User> tag includes individual user information, an <ID> tag includes a user ID, and a <Name> tag includes a user name. In this example shown in FIG. 6, the per-page user information list includes five <User> tags and one <Page> tag. For example, when it is assumed that the user selection screen 30 can display up to ten user-name buttons 31 on each page, and the user information list includes fifty pieces of user information, the per-page user information list includes five <Page> tags, and each of the <Page> tags includes ten <User> tags.

To return to the explanation of the flowchart shown in FIG. 4, the information issuing unit 1 creates user-name buttons 31 labeled user names to be displayed on page 1 of the user selection screen 30 based on the per-page user information, and sets up and displays the created user-name buttons 31 on predetermined positions of the user selection screen 30 (Step S3).

Then, the information issuing unit 1 creates the “NEXT” button 32, the “PREVIOUS” button 33, and the “NAME ENTRY” button 34, and sets up and displays the created “NEXT”, “PREVIOUS”, and “NAME ENTRY” buttons 32 to 34 on predetermined positions of the user selection screen 30 (Step S4). The process for displaying the user selection screen 30 on the touch panel 4 is completed.

When any of the buttons displayed on the touch panel 4 is touched by the user, the CPU (not shown) executes a corresponding process.

FIG. 7 is a flowchart of a process executed when the “NEXT” button 32 shown in FIG. 3 is touched.

When the user touches the “NEXT” button 32 (YES at Step S11), if a currently-displayed page is not the last page (NO at Step S12), the information issuing unit 1 acquires user information corresponding to the next page from the per-page user information list stored in the information storage unit 15, and displays corresponding user-name buttons 31 on the user selection screen 30 (Step S13). If the currently-displayed page is the last page (YES at Step S12), the information issuing unit 1 does not perform any process.

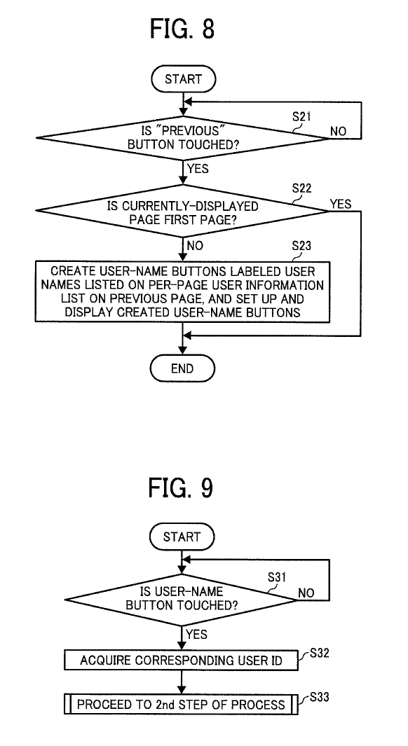

FIG. 8 is a flowchart of a process executed when the “PREVIOUS” button 33 shown in FIG. 3 is touched.

When the user touches the “PREVIOUS” button 33 (YES at Step S21), if a currently-displayed page is not the first page (NO at Step S22), the information issuing unit 1 acquires user information corresponding to the previous page from the per-page user information list stored in the information storage unit 15, and displays corresponding user-name buttons 31 on the user selection screen 30 (Step S23). If the currently-displayed page is the first page (YES at Step S22), the information issuing unit 1 does not perform any process.

FIG. 9 is a flowchart of a process executed when the user-name button 31 is touched.

When the user touches any of the displayed user-name buttons 31 (YES at Step S31), the information issuing unit 1 acquires a user ID corresponding to a user name of the touched user-name button 31 from the per-page user information list stored in the information storage unit 15 (Step S32), and stores the acquired user ID in the information storage unit 15. Hereinafter, such a stored user ID is referred to as a target user ID.

For example, when the user touches the user-name button 31 labeled “SHINAGAWA ICHIRO”, the information issuing unit 1 searches information on Shinagawa Ichiro as the user name in the per-page user information list, and acquires 10001 as a user ID of Shinagawa Ichiro (Step S32). Then, the process flow proceeds to the second step of the process (Step S33).

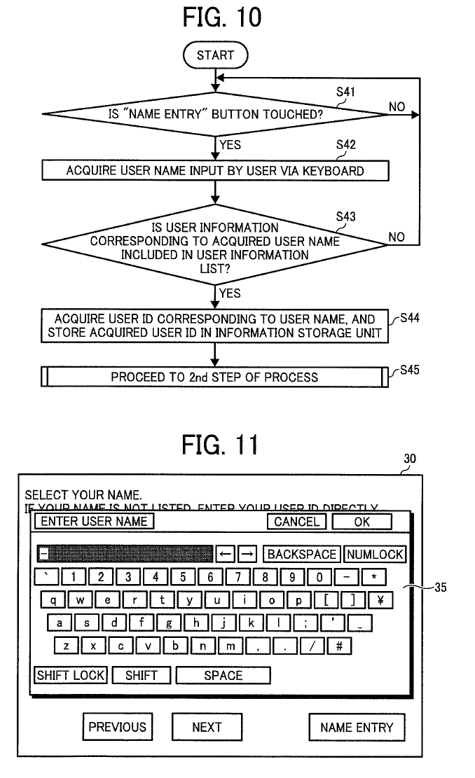

FIG. 10 is a flowchart of a process executed when the “NAME ENTRY” button 34 is touched.

When the user touches the “NAME ENTRY” button 34 (YES at Step S41), the information issuing unit 1 displays a pop-up window including a software keyboard 35 as the information input unit 12, as show in FIG. 11. When the user touches a key of the software keyboard 35, a character corresponding to the key is input to a text box located on top of the keys. In this case, the touch panel 4 functions as the information input unit 12 for entering the user name.

When the user presses an “OK” button, the information issuing unit 1 acquires character information on the characters input to the text box, i.e., the user name (Step S42).

Then, the information issuing unit 1 determines whether user information including the acquired user name is included in the user information list stored in the information storage unit 15 (Step S43).

When the user information including the acquired user name is included in the user information list (YES at Step S43), the information issuing unit 1 acquires a user ID corresponding to the acquired user name from the user information list stored in the information storage unit 15, and stores the acquired user ID as a target user ID in the information storage unit 15 (Step S44).

For example, when the user inputs “Shinagawa Ichiro” through the software keyboard 35, the information issuing unit 1 searches information on Shinagawa Ichiro as the user name in the user information list, and acquires 10001 as a user ID of Shinagawa Ichiro. When any user information including the acquired user name is not included in the user information list (NO at Step S43), the process flow returns to Step S41. At this time, although there is not illustrated by the accompanying drawing, for example, the information issuing unit 1 can display a dialog box indicating the user that ID is not found.

Through the above first step of the process, the information issuing unit 1 acquires a user ID (a target user ID) of a user who operates the system, and thereby identifying the user. Subsequently, the process flow proceeds to the second step of the process (Step S45).

[Second Step: User Authentication]

Next, user authentication is performed with the acquired target user ID and a password.

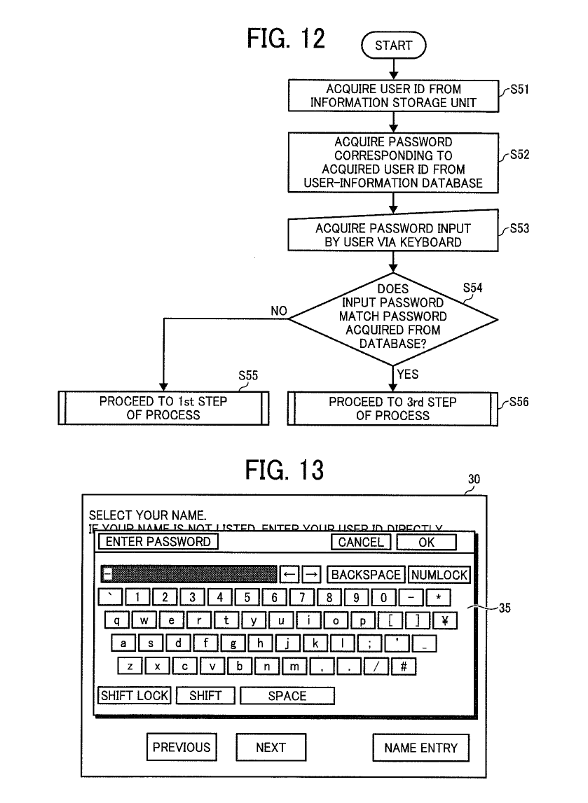

FIG. 12 is a flowchart of a process for password authentication.

First, the information issuing unit 1 accesses a resource [https://www.xxx.co.jp/WebService/UserPassword/[target user ID]] with the GET method, and acquires a password corresponding to the target user ID, which is acquired from the information storage unit 15 (Step S51), from the user-information database 22 shown in FIG. 2 (Step S52). For example, when the target user ID is 10001, the information issuing unit 1 accesses a resource [https://www.xxx.co.jp/WebService/UserPassword/10001], and acquires a password of Shinagawa Ichiro.

Upon completion of the acquisition of the password, as show in FIG. 13, the information issuing unit 1 displays a pop-up window including the software keyboard 35 as a password input unit on the touch panel 4. When the user touches a key of the software keyboard 35, a character corresponding to the key is input to a text box located on top of the keys. After the user inputs his password via the software keyboard 35, the user presses the “OK” button, so that the information issuing unit 1 acquires character information on characters input to the text box by the user, i.e., password information (Step S53). In this case, the touch panel 4 functions as the information input unit 12 for entering the password.

Then, the user authentication unit 14 checks whether the password input by the user via the software keyboard 35 matches the password acquired from the user-information database 22 (Step S54).

When the password input via the software keyboard 35 matches the password acquired from the user-information database 22 (YES at Step S54), the process flow then proceeds to the third step of the process (Step S56). On the other hand, when the password input via the software keyboard 35 does not match the password acquired from the user-information database 22 (NO at Step S54), the process flow returns to the first step of the process to start the process from the beginning (Step S55).

Incidentally, when the password input via the software keyboard 35 does not match the password acquired from the user-information database 22 (NO at Step S54), although there is not illustrated by the accompanying drawing, the information issuing unit 1 can display a dialog box indicating the mismatch between the passwords, and again display the pop-up window including the software keyboard 35 so as to ask the user to input the password.

Through the above second step of the process, the information issuing unit 1 completes the user authentication of the user who operates the system, and verifies whether the user is an authenticated user. Therefore, it is possible to prevent the image scanning/accumulating system from being operated by a malicious third person for illegitimate purposes.

[Third Step: Selection of Associated Task Information]

Subsequently, the information issuing unit 1 causes the user to select task information associated with the image data.

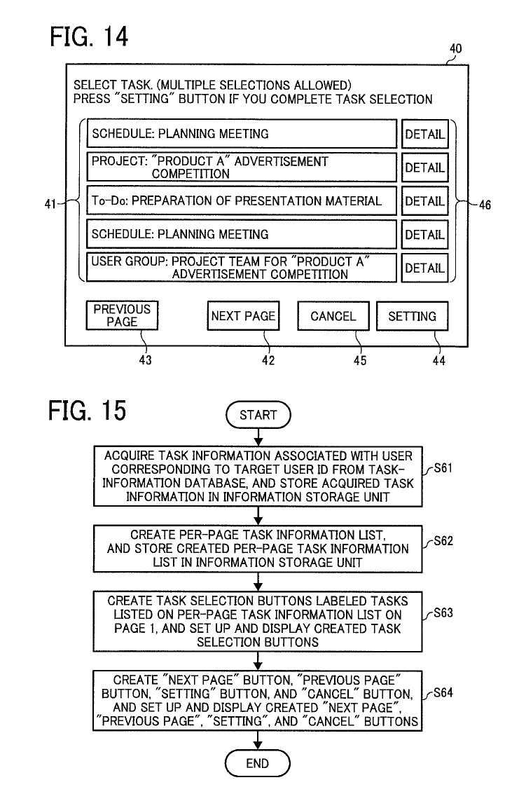

FIG. 14 is an explanatory diagram of an example of a task-information selection screen 40 displayed on the touch panel 4.

On the task-information selection screen 40 shown in FIG. 14, a plurality of task selection buttons 41 as the information selection unit 11 are displayed. The task selection buttons 41 are respectively labeled an outline of task information, such as “SCHEDULE”, “PROJECT”, “To-Do”, and “USER GROUP”.

Furthermore, a “NEXT PAGE” button 42 for switching to a next page, a “PREVIOUS PAGE” button 43 for switching to a previous page, a “SETTING” button 44 for switching to a parameter setting screen upon completion of selection of task information, a “CANCEL” button 45 for switching to the user selection screen 30, and “DETAIL” buttons 46 for displaying detailed information of corresponding task information are displayed on the task-information selection screen 40. The “DETAIL” buttons 46 are set up beside the task selection buttons 41, respectively.

The user touches desired one of the displayed task selection buttons 41 to select task information. Each time the user touches any of the task selection buttons 41, the information issuing unit 1 switches the display mode of the task selection button 41 between a normal display mode and highlight display mode, and thereby indicating the user whether the task selection button 41 is selected.

When desired task information is not displayed on the task-information selection screen 40, the user touches either the “NEXT PAGE” button 42 or the “PREVIOUS PAGE” button 43, so that the information issuing unit 1 displays other task information.

When the user touches the “SETTING” button 44, the information issuing unit 1 displays a printing-parameter setting screen to be described later.

When the user touches the “CANCEL” button 45, the information issuing unit 1 displays the user selection screen 30.

Incidentally, on the task-information selection screen 40 shown in FIG. 14, five pieces of task information (i.e., five numbers of the task selection buttons 41) are displayed. In this example, the third and fourth task information (i.e., “To-Do: PREPARATION OF PRESENTATION MATERIAL” and “SCHEDULE: PLANNING MEETING”) are selected.

Subsequently, a process for displaying the task-information selection screen 40 on the touch panel 4 performed by the information issuing unit 1 is explained below with reference to FIG. 15. FIG. 15 is a flowchart of the process for displaying the task-information selection screen 40.

First, the information issuing unit 1 accesses a resource [http://www.xxx.co.jp/WebService/Task/[target user ID]] with the GET method, and acquires task information associated with a user corresponding to the target user ID from the task-information database 20, and stores the acquired task information in the information storage unit 15 (Step S61).

For example, when the target user ID is 10001, the information issuing unit 1 accesses a resource [http://www.xxx.co.jp/WebService/Task/10001], and acquires task information associated with Shinagawa Ichiro.

In the first step of the process, the information issuing unit 1 acquires the user ID in advance. Therefore, the information issuing unit 1 can narrow task information to be selected down to task information associated with the user corresponding to the acquired user ID. Thus, it is possible to lessen a burden on the user when the user selects task information.

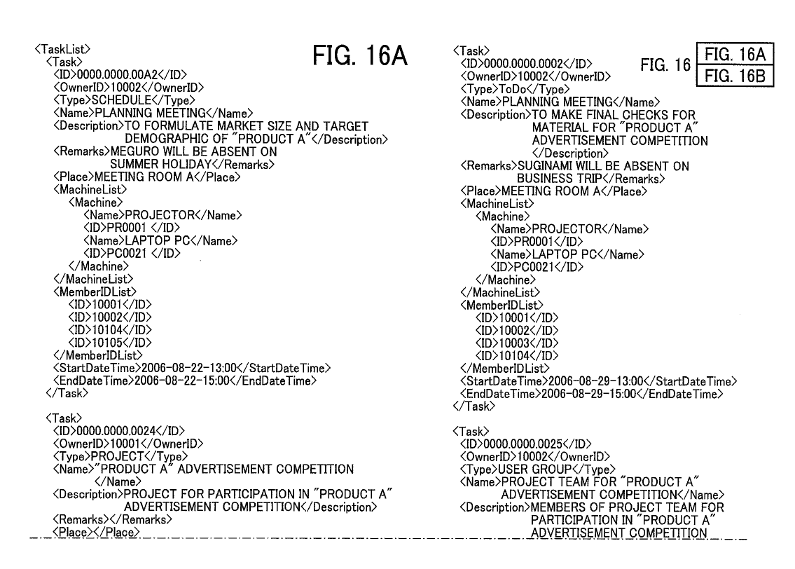

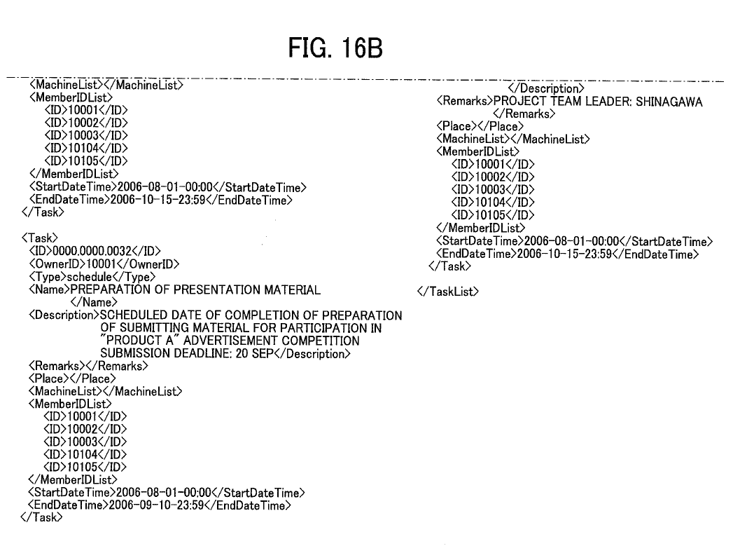

FIG. 16 is an explanatory diagram of an example of a list of the acquired task information. In this example, the task information list is described in an XML format. Each of <Task> tags includes individual task information. An <ID> tag includes an ID of task information. An <Owner ID> tag includes an ID of a creator who creates the task information. A <Type> tag includes a type of the task information (in this example, any of the following four types: “SCHEDULE”, “PROJECT”, “To-Do”, and “USER GROUP”). A <Name> tag includes a name of the task information. A <Description> tag includes an outline of a task. A <Remarks> tag includes information on remarks. A <Place> tag includes information on a place associated with the task information, such as a place where a meeting is held. A <Machine> tag includes information on a device associated with the task information. A <Name> tag in the <Machine> tag includes a name of the device, and an <ID> tag in the <Machine> tag includes an ID of the device. An <ID> tag in a <Member ID List> tag includes a user ID associated with the task information. A <Start Date Time> tag includes start date and time associated with the task information, such as a starting time of a meeting or a start date of a project. An <End Date Time> tag includes end date and time associated with the task information, such as an ending time of the meeting or an end date of the project.

Incidentally, data in the task-information database 20 does not always have to be managed in the XML format as shown in FIG. 16. Furthermore, components of the task information are not limited to those shown in FIG. 16.

To return to the explanation of the flowchart shown in FIG. 15, the information issuing unit 1 creates a per-page task information list from the acquired task information list so as to display predetermined numbers of task selection buttons on the display screen on a per-page basis, and stores the created per-page task information list in the information storage unit 15 (Step S62).

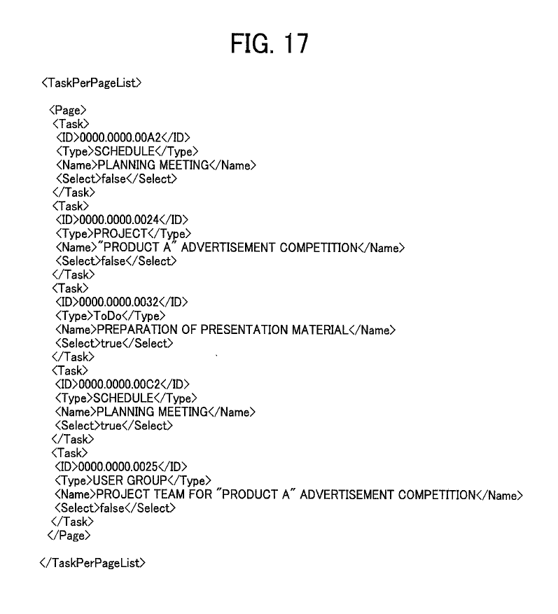

FIG. 17 is an explanatory diagram of an example of the created per-page task information list. In this example, the per-page task information list is described in an XML format. A <Page> tag includes pieces of task information per page. A <Task> tag includes individual task information. An <ID> tag includes an ID of the task information. A <Type> tag includes a type of the task information. A <Name> tag includes a name of the task information. A <Select> tag includes flag information indicating whether the task information is selected. In this example, the number of tasks is five, so that the per-page task information list includes one <Page> tag. For example, when it is assumed that each page can cover up to five pieces of task information, and the total number of task information is fifty, the per-page task information list includes ten <Page> tags, and each of the <Page> tags includes five <Task> tags.

To return to the explanation of the flowchart shown in FIG. 15, the information issuing unit 1 creates task selection buttons 41 that are respectively labeled a type and a name of each piece of task information based on the stored per-page task information list, and sets up and displays the created task selection buttons 41 on predetermined positions of the task-information selection screen 40 (Step S63). In addition, the information issuing unit 1 creates “DETAIL” button 46 corresponding to the task information, and sets up and displays the created “DETAIL” button 46 on the right side of the task selection buttons 41 respectively.

Then, the information issuing unit 1 creates the “NEXT PAGE” button 42, the “PREVIOUS PAGE” button 43, the “SETTING” button 44, and the “CANCEL” button 45, and sets up and displays the created “NEXT PAGE”, “PREVIOUS PAGE”, “SETTING”, and “CANCEL” buttons 42 to 45 on predetermined positions of the task-information selection screen 40 (Step S64).

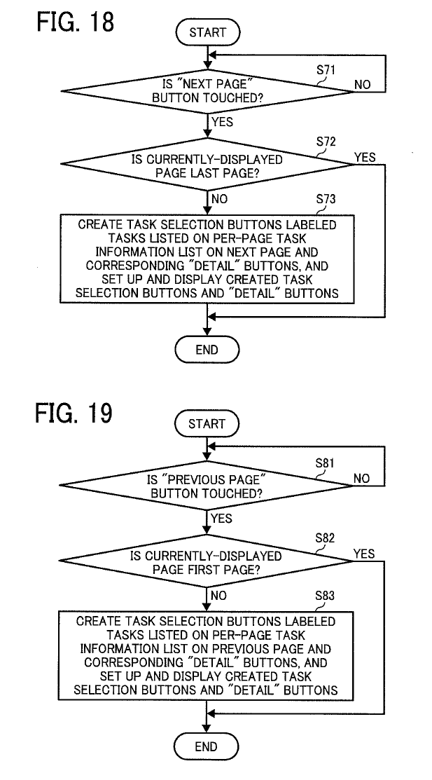

FIG. 18 is a flowchart of a process executed when the “NEXT PAGE” button 42 is touched.

When the user touches the “NEXT PAGE” button 42 (YES at Step S71), if a currently-displayed page is not the last page (NO at Step S72), the information issuing unit 1 acquires task information corresponding to the next page from the displayed per-page task information list, and displays corresponding task selection buttons 41 and “DETAIL” buttons 46 (Step S73). On the other hand, if the currently-displayed page is the last page (YES at Step S72), the information issuing unit 1 does not perform any process.

FIG. 19 is a flowchart of a process executed when the “PREVIOUS PAGE” button 43 is touched.

When the user touches the “PREVIOUS PAGE” button 43 (YES at Step S81), if a currently-displayed page is not the first page (NO at Step S82), the information issuing unit 1 acquires task information corresponding to the previous page from the displayed per-page task information list, and displays corresponding task selection buttons 41 and “DETAIL” buttons 46 (Step S83). On the other hand, if the currently-displayed page is the first page (YES at Step S82), the information issuing unit 1 does not perform any process.

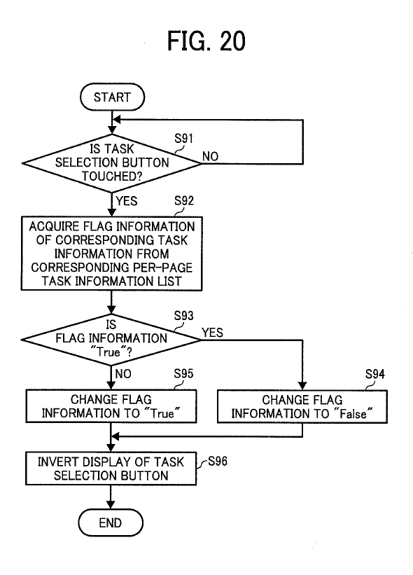

FIG. 20 is a flowchart of a process executed when the task selection button 41 is touched.

When the user touches the task selection button 41 (YES at Step S91), the information issuing unit 1 acquires flag information (a component in a <Select> tag) of corresponding task information from the per-page task information list stored in the information storage unit 15 (Step S92). When the flag information is “True” (YES at Step S93), the information issuing unit 1 changes the flag information of the corresponding task information in the per-page task information list to “False” (Step S94). On the other hand, when the flag information is “False” (NO at Step S93), the information issuing unit 1 changes the flag information of the corresponding task information in the per-page task information list to “True” (Step S95). When the task selection button 41 is originally displayed on the normal display, the information issuing unit 1 switches the display mode of the task selection button 41 to the highlight display; and conversely, when the task selection button 41 is originally displayed on the highlight display, the information issuing unit 1 switches the display mode of the task selection button 41 to the normal display (Step S96).

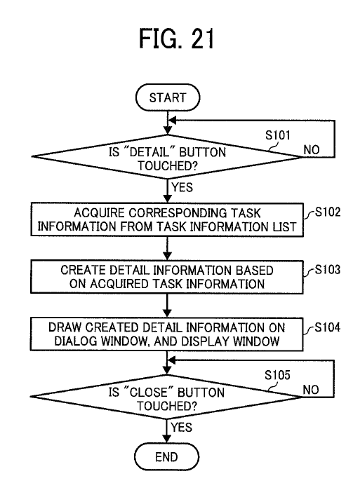

FIG. 21 is a flowchart of a process executed when the “DETAIL” button 46 is touched.

When the user touches the “DETAIL” button 46 (YES at Step S101), the information issuing unit 1 acquires corresponding task information from the task information list stored in the information storage unit 15 (Step S102). The information issuing unit 1 formats the acquired task information, and creates detail information (Step S103). Then, the information issuing unit 1 draws the detail information on a dialog window including a “CLOSE” button (Step S104). When the user touches the “CLOSE” button (YES at Step S105), the information issuing unit 1 closes the dialog window.

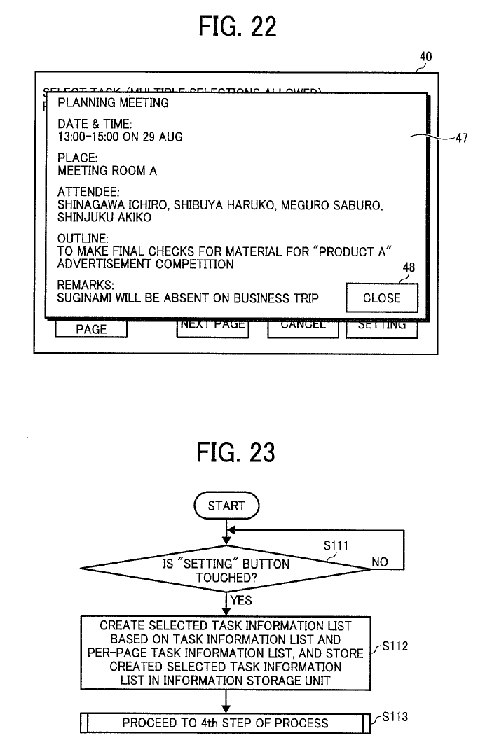

FIG. 22 is an explanatory diagram of an example of a dialog window 47 displaying thereon detail information. On the dialog window 47, detail information acquired when the user touches the “DETAIL” button 46 of the fourth task information (SCHEDULE: PLANNING MEETING) on the task-information selection screen 40 shown in FIG. 14 is displayed.

When the user presses a “CLOSE” button 48, the dialog window 47 is closed.

FIG. 23 is a flowchart of a process executed when the “SETTING” button 44 shown in FIG. 14 is touched.

When the user touches the “SETTING” button 44 (YES at Step S111), the information issuing unit 1 creates a selected task information list, including an ID of a selected task and a user ID of a user associated with the selected task, based on the task information list and the per-page task information list those stored in the information storage unit 15, and stores the created selected task information list in the information storage unit 15 (Step S112). After that, the process flow proceeds to the fourth step of the process (Step S113).

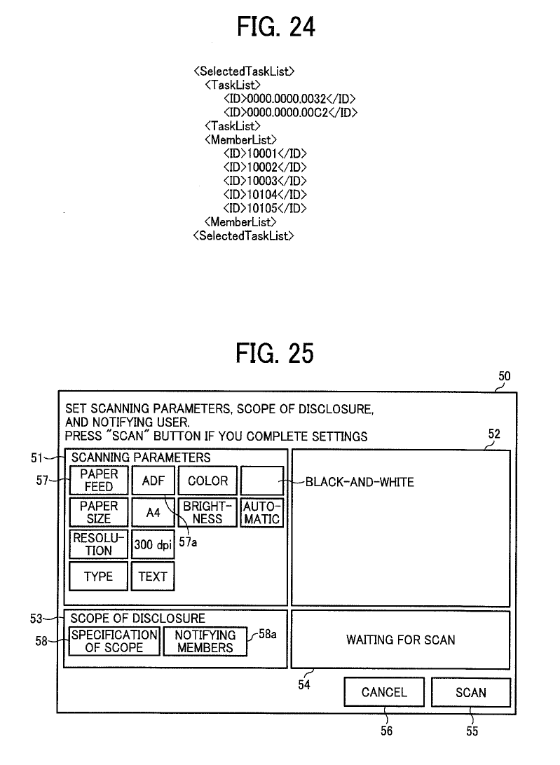

FIG. 24 is an explanatory diagram of an example of the created selected task information list.

In this example, the selected task information list is described in an XML format. An <ID> tag in a <Task List> tag includes an ID of a selected task, and <ID> tags in a <Member List> tag include user IDs of all users associated with the selected task respectively.

[Fourth Step: Scanning-Parameter Setting and Execution of Scan]

Subsequently, a process for setting scanning parameters and scanning a paper-based document, as the fourth step of the process, is explained in detail below.

FIG. 25 is an explanatory diagram of an example of a parameter setting screen 50 displayed on the touch panel 4.

On the parameter setting screen 50 shown in FIG. 25, a scanning-parameter setting area 51, a notifying-user selection area 52, a scope-of-disclosure setting area 53, a message display area 54, a “SCAN” button 55, and a “CANCEL” button 56 are displayed.

The user touches any of scan setting buttons 57 as the information selection unit 11 displayed in the scanning-parameter setting area 51, and sets a corresponding scanning parameter for scanning a paper-based document. In this example, the scan setting buttons 57 are buttons for setting paper feed, a paper size, the resolution, a type of content, color, and the brightness, respectively.

As a value of the paper feed, any of “ADF (automatic document feed)” and “MANUAL (manual paper feed)” can be selected. As a value of the paper size, any of “A4”, “B4”, and “B5” can be selected. As a value of the resolution, any of “300 dpi (dots per inch)” and “400 dpi” can be selected. As a value of the type of content, any of “photo”, “text”, and “mixed” can be selected. As a value of the color of content, any of “color” and “black-and-white” can be selected. As a value of the brightness, any of “automatic”, “dark”, and “light” can be selected. Incidentally, such setting items and setting values are not limited to the above. Arbitrary setting items and setting values are used depending on an image pickup unit used.

The user touches a scope-of-disclosure setting button 58 as the information selection unit 11 displayed in the scope-of-disclosure setting area 53, and sets the scope of disclosure of image data on a document to be scanned. As a value of the scope of disclosure, any of “public” enabling the general public to access the image data, “private” enabling only registrants to access the image data, and “notifying members” enabling only registrants and a user as an announcer to access the image data can be selected. Values of the scope of disclosure are not limited to the above three setting values. Alternatively, the information issuing unit 1 can employ a higher-level access control system.

When the user touches the “SCAN” button 55, the information issuing unit 1 executes the fifth step of the process with the set scanning parameters, scope-of-disclosure information, and notifying-user information.

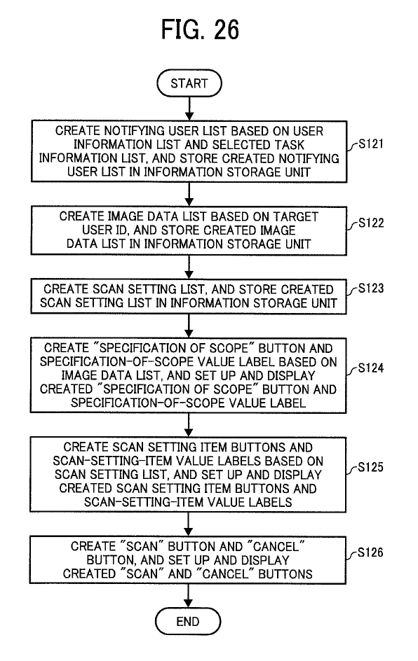

FIG. 26 is a flowchart of a process for displaying the parameter setting screen 50.

First, the information issuing unit 1 creates a notifying user list based on the user information list and the selected task information list those stored in the information storage unit 15, and stores the created notifying user list in the information storage unit 15 (Step S121).

Then, the information issuing unit 1 creates an image data list based on the target user ID, and stores the created image data list in the information storage unit 15 (Step S122).

Furthermore, the information issuing unit 1 creates a scan setting list, and stores the created scan setting list in the information storage unit 15 (Step S123).

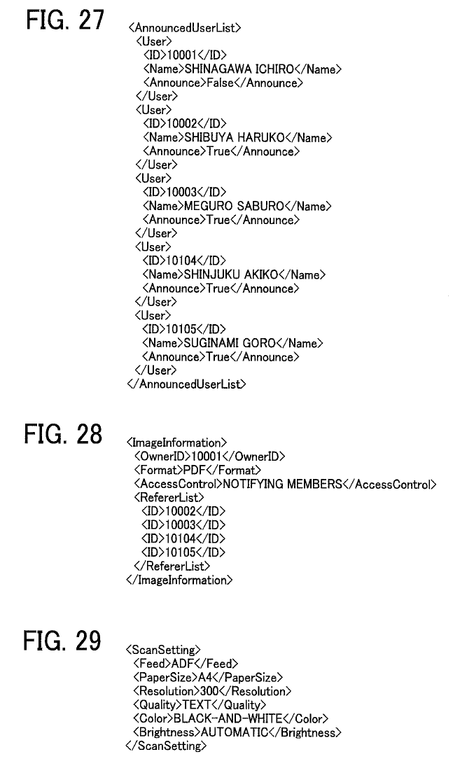

FIG. 27 is an explanatory diagram of an example of the created notifying user list.

In this example, the notifying user list is described in an XML format. An <ID> tag in a <User> tag includes a user ID, a <Name> tag in the <User> tag includes a name of a user, and an <Announce> tag in the <User> tag includes flag information indicating whether the user is notified.

Incidentally, when creating the notifying user list, the information issuing unit 1 does not recognize flag information indicating whether each of users is to be notified. Therefore, the information issuing unit 1 assigns “False” as a default value to all the <Announce> tags for all users.

FIG. 28 is an explanatory diagram of an example of the created image data list.

In this example, the image data list is described in an XML format. An <Owner ID> tag includes a target user ID, a <Format> tag includes a format of image data to be registered, an <Access Control> tag includes scope-of-disclosure information, and an <ID> tag in a <Referer List> tag includes a user ID of a member to be notified if a value of the scope of disclosure is “NOTIFYING MEMBERS”.

FIG. 29 is an explanatory diagram of an example of the created scan setting list.

The scan setting list is described in an XML format in this example. A <Feed> tag indicates paper feed, a <Paper Size> tag indicates a paper size, a <Resolution> tag indicates the resolution, a <Quality> tag indicates a type of content, a <color> tag indicates color of the content, and a <Brightness> tag indicates the density.

When creating the scan setting list, the information issuing unit 1 does not recognize each of setting values, so that the information issuing unit 1 sets a default value as each of the setting values.

To return to the explanation of the flowchart shown in FIG. 26, the information issuing unit 1 creates the scope-of-disclosure setting button 58 labeled “SPECIFICATION OF SCOPE” and a specification-of-scope value label 58a displaying thereon a value of the specification of scope based on the stored image data list, and sets up and displays the created scope-of-disclosure setting button 58 and the specification-of-scope value label 58a in the scope-of-disclosure setting area 53 (Step S124).

Then, the information issuing unit 1 creates the scan setting buttons 57 labeled setting items respectively and scan-setting-value labels 57a displaying thereon setting values respectively based on the scan setting list stored in the information storage unit 15, and sets up and displays the created scan setting buttons 57 and the scan-setting-value labels 57a in the scanning-parameter setting area 51 (Step S125).

After that, the information issuing unit 1 creates the “SCAN” button 55 and the “CANCEL” button 56, and sets up and displays the created “SCAN” and “CANCEL” buttons 55 and 56 on predetermined positions of the parameter setting screen 50 (Step S126).

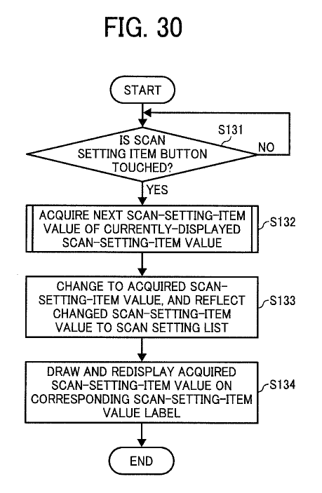

FIG. 30 is a flowchart of a process executed when the scan setting button 57 is touched.

When the user touches the scan setting button 57 (YES at Step S131), the information issuing unit 1 acquires a setting value next to a currently-displayed setting value from the scan setting list (Step S132).

Incidentally, if the currently-displayed setting value is the last value on the scan setting list, the first setting value on the scan setting list is acquired. For example, when the setting item is “PAPER FEED”, a setting-value list of the paper feed shows {“ADF”, “MANUAL”}. If the currently-displayed setting value is “ADF”, “MANUAL” is acquired as the next setting value. On the other hand, if the currently-displayed setting value is “MANUAL”, “ADF” is acquired. Furthermore, when the setting item is “PAPER SIZE”, a setting-value list of the paper size shows {“A4”, “B4”, “B5”}. If the currently-displayed setting value is “A4”, “B4” is acquired as the next setting value. If the currently-displayed setting value is “B5”, “A4” is acquired as the next setting value.

Incidentally, in the fifth step of the process, for the sake of convenience, per-page display switching is not described. However, it can be configured to display the buttons on a per-page basis by switching the display screens on a per-page basis as the user-name buttons 31 in the first step of the process and the task selection button 41 in the third step of the process.

To return to the explanation of the flowchart shown in FIG. 30, the information issuing unit 1 changes the setting value of the corresponding setting item to the acquired setting value, and thereby reflecting the acquired setting value as a new setting value to the scan setting list (Step S133).

Then, the information issuing unit 1 draws/redisplays the new setting value on the corresponding scan-setting-value label 57a (Step S134).

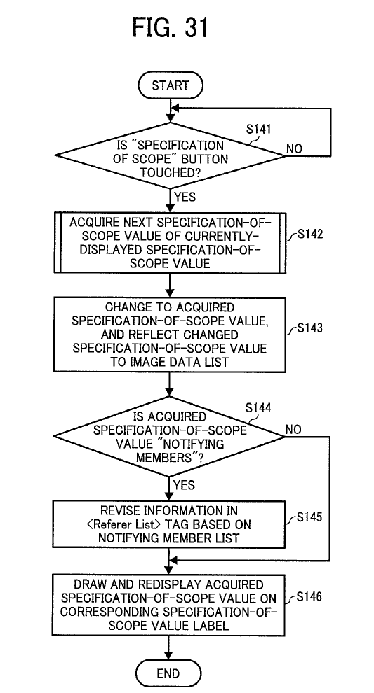

FIG. 31 is a flowchart of a process executed when the scope-of-disclosure setting button 58 is touched.

When the user touches the scope-of-disclosure setting button 58 (YES at Step S141), the information issuing unit 1 acquires a setting value next to a currently-displayed setting value from a setting-value list of the specification of scope (Step S142). Incidentally, if the currently-displayed setting value is the last value on the setting-value list, the first setting value on the setting-value list is acquired. The setting-value list of the specification of scope shows {“PUBLIC”, “PRIVATE”, “NOTIFYING MEMBERS”}. For example, when the currently-displayed setting value is “PRIVATE”, “NOTIFYING MEMBERS” is acquired as the next setting value. Furthermore, when the currently-displayed setting value is “NOTIFYING MEMBERS”, “PUBLIC” is acquired as the next setting value.

Then, the information issuing unit 1 changes the setting value of the specification of scope to the acquired setting value, and thereby reflecting the acquired setting value as a new setting value to the image data list (Step S143). Incidentally, when the currently-displayed setting value is “NOTIFYING MEMBERS”, the information issuing unit 1 clears components in the <Referer List> tag.

Furthermore, when the new setting value is “NOTIFYING MEMBERS” (YES at Step S144), the information issuing unit 1 adds a user ID of a user flagged with “True” on the notifying member list to the image data list as a component of an <ID> tag in the <Referer List> tag (Step S145).

Then, the information issuing unit 1 draws/redisplays the new setting value on the specification-of-scope value label 58a (Step S146).

After that, when the user touches the “SCAN” button 55, the information issuing unit 1 executes the fifth step of the process, i.e., registration of image data and acquisition of reference information.

On the other hand, when the user touches the “CANCEL” button 56, the information issuing unit 1 displays the user selection screen 30, and the process flow returns to the first step of the process.

[Fifth Step: Registration of Image Data and Acquisition of Reference Information]

When the information issuing unit 1 is instructed to start scanning, the information issuing unit 1 causes the image pickup unit 13 (the scanner 3) to scan a document in accordance with setting values on the scan setting list stored in the information storage unit 15 and then to store image data on the scanned document in the information storage unit 15.

In this example, as the scanner 3, any type of scanner can be used as long as the scanner can scan a document in accordance with setting values and acquire image data. In this example, it is assumed that the acquired image data can be accessed through a file path “scaneddata.pdf”, and the image data is stored in a Portable Document Format (PDF) format.

A process for registering the image data and acquiring reference information of the image data is explained in detail below.

The information issuing unit 1 accesses [http://www.xxx.co.jp/WebService/ImageData] with the POST method together with the image data referred to scaneddata.pdf and the image data list stored in the information storage unit 15, and registers the image data on the image-data database 21. Specifically, the information issuing unit 1 transmits the image data in multipart forms and the parameterized image data list.

When the image data is successfully registered, the information issuing unit 1 acquires an image-data reference list as reference information of the image data.

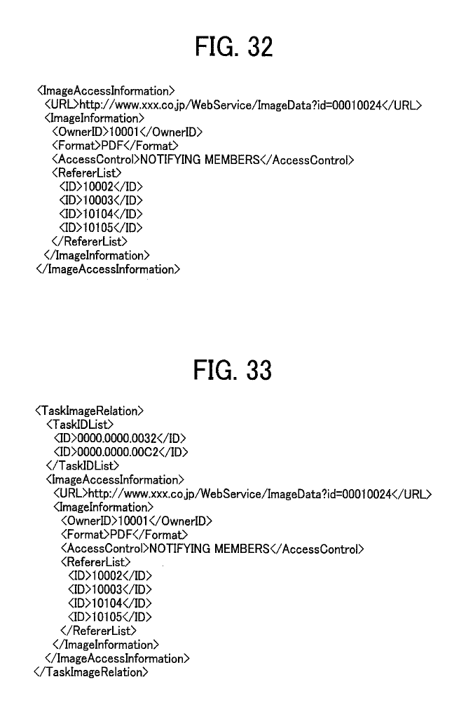

FIG. 32 is an explanatory diagram of an example of the acquired image-data reference list.

In this example, the image-data reference list is described in an XML format. A <URL> tag indicates a resource to which the registered image data is referred. Other tags are identical to those in the image data list, and the description of those tags is omitted.

This example shows the information issuing unit 1 acquires image data having an ID of 00010024 by accessing a resource [http://www.xxx.co.jp/WebService/ImageData/00010024] with the GET method.

When the specification of scope is “notifying users”, it is necessary to restrict access to the web service with a user ID and a password. For example, Apache Basic Authentication can be employed to restrict the access to the web service.

The acquired image-data reference list is stored in the information storage unit 15, and then a process for registering association information in the sixth step of the process is executed.

[Sixth Step: Registration of Association Information]

The information issuing unit 1 registers information on an association between the read image data and the selected task information on the association-information database 23 in the information managing unit 2.

As the association information of the image data and the selected task information, the reference information of the registered image data and the task information selected by the user can be registered. In this case, the association information can be created based on the stored image-data reference list and selected task information list.

FIG. 33 is an explanatory diagram of an example of an association information list including information on the association between the image data and the selected task information.

In this example, the association information list is described in an XML format. An <ID> tag in a <Task ID List> tag indicates an ID of selected task information Other tags are identical to those in the image-data reference list, and the description of those tags is omitted.

The information issuing unit 1 accesses [http://www.xxx.co.jp/WebService/RelativeInformation] with the POST method while properly parameterizing contents of the list, and registers the association information list on the association-information database 23.

Upon completion of the registration, a process for notifying an associated user in the seventh step of the process is executed.

[Seventh Step: Notification to Associated User]

Upon completion of the registration of the image data and the acquisition and storage of the image-data reference list, the information notifying unit 17 sends an e-mail to a selected user so as to notify the user that the image data is registered in association with the associated task information.

In this manner, an e-mail is used as a notifying means, so that the information notifying unit 17 need not include any specific means. In other words, the information notifying unit 17 can notify a user with a typical communication means.

First, the information notifying unit 17 creates a content of an e-mail to be sent based on the association information list of information on the association between the image data and the selected task information, the target user ID, the user information list, and the task information list.

The content of the e-mail includes a registrant of the image data, the reference information of the image data, and the associated task information.

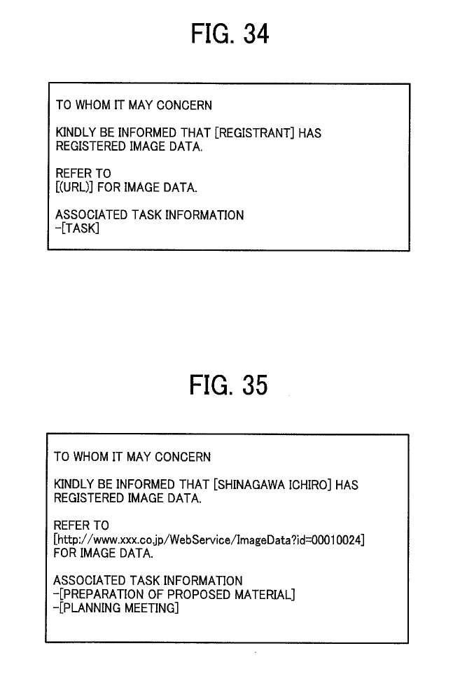

FIG. 34 is an explanatory diagram of an example of a content of an e-mail.

In an actual content, items [REGISTRANT], [URL], and [TASK] shown in FIG. 34 are replaced by appropriate values, respectively. Incidentally, a plurality of [TASK] can be inserted in the e-mail.

Specifically, as [REGISTRANT], a user name corresponding to the target user ID in the user information list can be inserted therein. As [URL], a value of a <URL> tag in the association information list can be inserted therein. As [TASK], a value of a <ID> tag in a <Task ID List> tag in the association information list, i.e., a task ID is acquired, and a task name corresponding to the acquired task ID in the task information list can be inserted therein.

FIG. 35 is an explanatory diagram of an example of the content of the e-mail that the items [REGISTRANT], [URL], and [TASK] shown in FIG. 34 are replaced by values.

Next, the information notifying unit 17 extracts an e-mail address of a notifying user from the notifying user list and the user information list.

Specifically, the information notifying unit 17 acquires a value of an <ID> tag, i.e., a user ID of a user having an <Announce> tag including “True” in the notifying user list, and further acquires a mail address corresponding to the acquired user ID from the user information list.

After that, the information notifying unit 17 sends the e-mail including the created content to a destination having the extracted e-mail address.

Incidentally, the communication means is not limited to an e-mail. Alternatively, a commonly-used communication means, such as a javamail, can be used as the communication means.

Subsequently, a process performed in an image scanning/accumulating system according to a second embodiment of the present invention is explained below. In the second embodiment, it is configured that, in the fourth step of the process, a user can edit whether a notifying user included in the notifying user list is to be notified through the parameter setting screen 50.

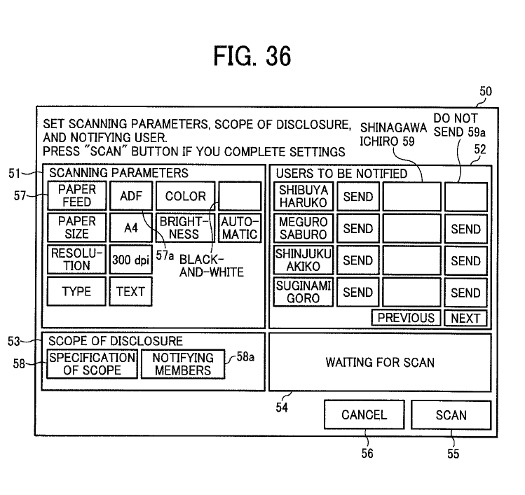

FIG. 36 is an explanatory diagram of an example of the parameter setting screen 50 according to the second embodiment.

The scanning-parameter setting area 51 and the scope-of-disclosure setting area 53 are identical to those shown in FIG. 25, and the description of those areas is omitted.

In the parameter setting screen 50 according to the second embodiment, on the notifying-user selection area 52 (as a destination selection screen), notifying user buttons 59 as the information selection unit 11 labeled user names listed on the notifying user list stored in the information storage unit 15 and notification flag labels 59a indicating whether a corresponding user is to be notified are set up and displayed.

Incidentally, in this example, for the sake of convenience, per-page display switching is not described. However, it can be configured to display the notifying user buttons 59 on a per-page basis by switching the display screens on a per-page basis in the same manner as the user-name buttons 31 in the first step of the process and the task selection button 41 in the third step of the process.

The parameter setting screen 50 shown in FIG. 36 includes the scanning-parameter setting area 51, the notifying-user selection area 52, the scope-of-disclosure setting area 53, the message display area 54, the “SCAN” button 55, and the “CANCEL” button 56. The user presses any of the buttons displayed in the scanning-parameter setting area 51, the notifying-user selection area 52, and the scope-of-disclosure setting area 53, and revises a corresponding setting value.

When a desired user name is not displayed on the display screen in the notifying-user selection area 52, the user just presses a “PREVIOUS” button or a “NEXT” button, which are located on a lower part of the area, so that other user names are displayed thereon.

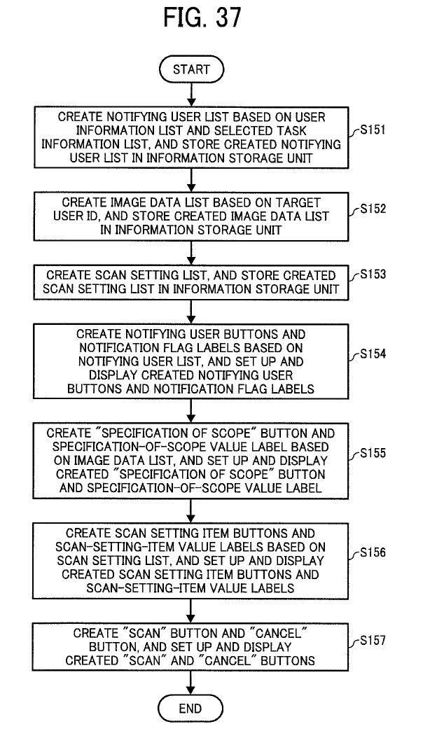

FIG. 37 is a flowchart of a process for displaying the parameter setting screen 50 shown in FIG. 36.

First, the information issuing unit 1 creates a notifying user list based on the user information list and the selected task information list those stored in the information storage unit 15, and stores the created notifying user list in the information storage unit 15 (Step S151).

Then, the information issuing unit 1 creates an image data list based on the target user ID, and stores the created image data list in the information storage unit 15 (Step S152).

Furthermore, the information issuing unit 1 creates a scan setting list, and stores the created scan setting list in the information storage unit 15 (Step S153).

Then, the information issuing unit 1 creates the notifying user buttons 59 and the notification flag labels 59a based on the notifying user list, and sets up and displays the created notifying user buttons 59 and notification flag labels 59a in the notifying-user selection area 52 (Step S154).

After that, the information issuing unit 1 creates the scope-of-disclosure setting button 58 labeled “SPECIFICATION OF SCOPE” as the information selection unit 11 and the specification-of-scope value label 58a displaying thereon a value of the specification of scope based on the stored image data list, and sets up and displays the created scope-of-disclosure setting button 58 and the specification-of-scope value label 58a in the scope-of-disclosure setting area 53 (Step S155).

Then, the information issuing unit 1 creates the scan setting buttons 57 labeled setting items respectively and the scan-setting-value labels 57a displaying thereon setting values respectively based on the scan setting list stored in the information storage unit 15, and sets up and displays the created scan setting buttons 57 and scan-setting-value labels 57a in the scanning-parameter setting area 51 (Step S156).

After that, the information issuing unit 1 creates the “SCAN” button 55 and the “CANCEL” button 56, and sets up and displays the created “SCAN” and “CANCEL” buttons 55 and 56 on predetermined positions of the parameter setting screen 50 (Step S157).

The notifying user list, the image data list, and the scan setting list used in the above are identical to those shown in FIGS. 27, 28, and 29 respectively.

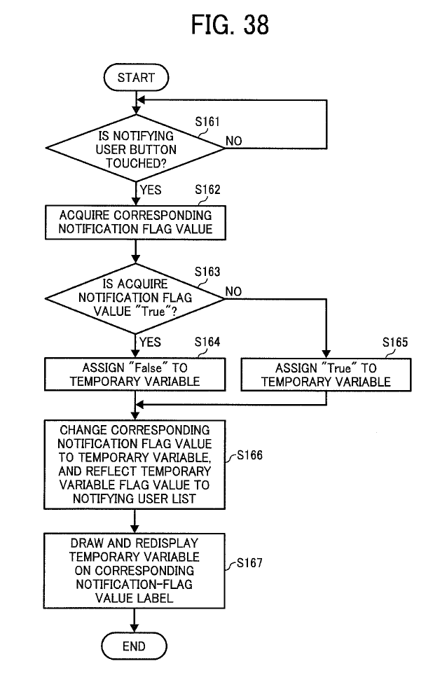

FIG. 38 is a flowchart of a process executed when the notifying user button 59 is touched. When the user touches the notifying user button 59 (YES at Step S161), the information issuing unit 1 acquires a value of a corresponding notification flag from the notifying user list (Step S162).

When the acquired notification flag value is “True” (YES at Step S163), the information issuing unit 1 assigns “False” to a temporary variable (Step S164). On the other hand, when the acquired notification flag value is “False” (NO at Step S163), the information issuing unit 1 assigns “True” to the temporary variable (Step S165).

Then, the information issuing unit 1 changes a corresponding notification flag value in the notifying user list to the temporary variable, and reflects the temporary variable to the notifying user list (Step S166). After that, the information issuing unit 1 draws/redisplays the temporary variable on the corresponding notification flag label 59a (Step S167).

With the notifying user list changed in the above fourth step of the process, the following fifth to seventh steps of the process are performed.

Subsequently, other functional configurations of the image scanning/accumulating system having the different hardware configuration as shown in FIGS. 1B to 1D are explained below. The portions identical to those in FIG. 2 for the image scanning/accumulating system having the hardware configuration shown in FIG. 1A are denoted with the same reference numerals, and the operational description of those portions is omitted. Only a difference from the configuration shown in FIG. 2 is described below.

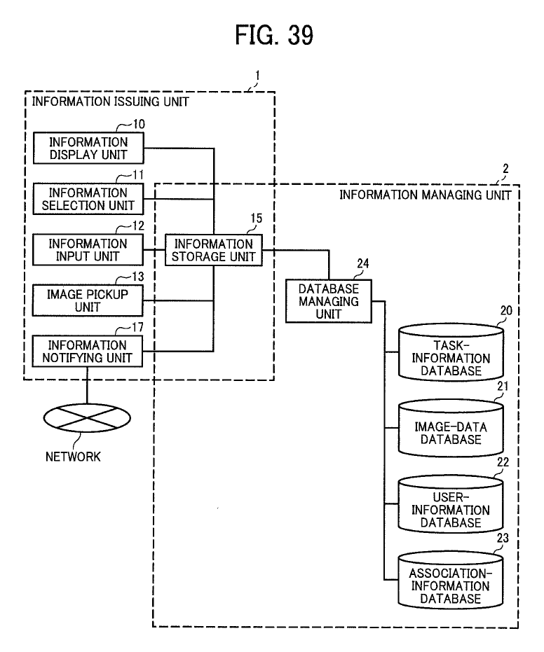

FIG. 39 is a functional block diagram of the image scanning/accumulating system having the hardware configuration shown in FIG. 1B.

In the configuration shown in FIG. 39, the computer connected to the network NW, the scanner 3 (the image pickup unit 13), and the touch panel 4 (the information display unit 10) serves as both the information issuing unit 1 and the information managing unit 2. Therefore, it is not necessary to provide the information communication units 16 and 26 for exchanging information between the information issuing unit 1 and the information managing unit 2 via the network NW. Furthermore, the information issuing unit 1 and the information managing unit 2 share the information storage unit 15 built in the computer, so that it is not necessary to provide the information storage unit 25.

In this example, when a user logs on the computer, it can be considered that the user has been authenticated. Therefore, it is not necessary to provide the user authentication unit 14 shown in FIG. 2. Furthermore, instead of the direct touch on the button displayed on the touch panel 4, the user can click the button with a mouse (not shown) included in the computer. Or, for example, when the user inputs a user name, the user can input the user name with a keyboard (not shown) included in the computer instead of the software keyboard 35.

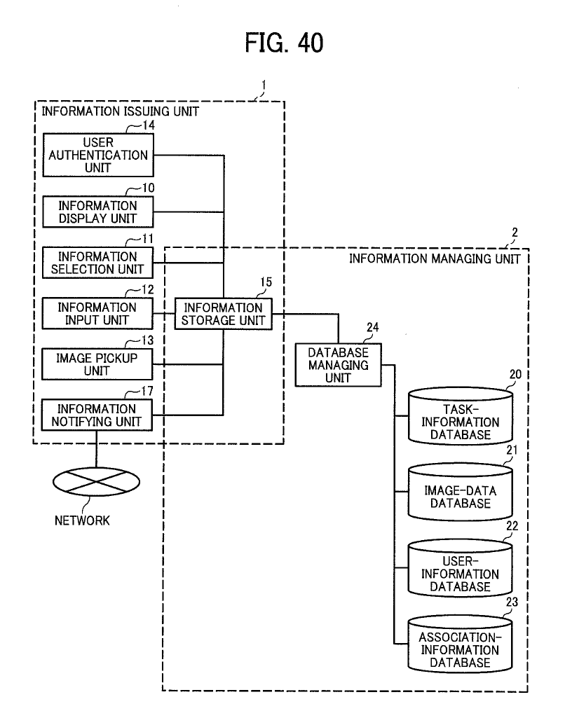

FIG. 40 is a functional block diagram of the image scanning/accumulating system having the hardware configuration shown in FIG. 1C.

In the configuration shown in FIG. 40, the MFP including the scanner 3 and the touch panel 4 serves as both the information issuing unit 1 and the information managing unit 2. In the same manner as the case shown in FIG. 39, it is not necessary to provide the information communication units 16 and 26 for exchanging information between the information issuing unit 1 and the information managing unit 2 via the network NW. Furthermore, the information issuing unit 1 and the information managing unit 2 share the information storage unit 15, so that it is not necessary to provide the information storage unit 25.

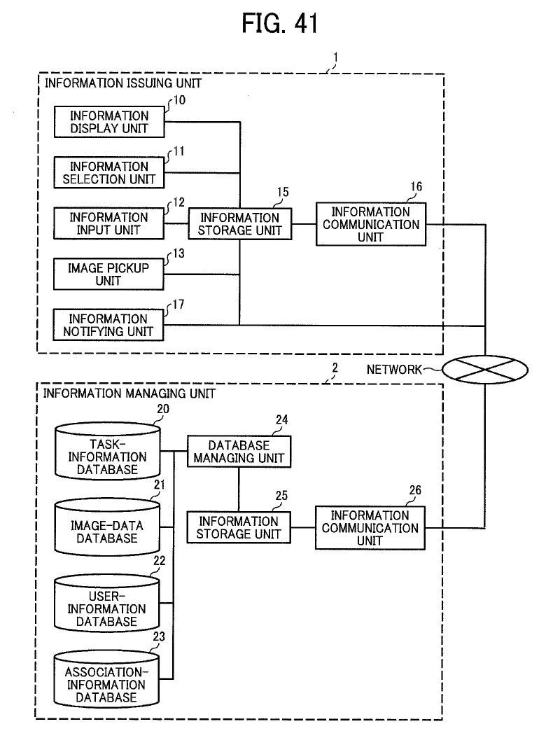

FIG. 41 is a functional block diagram of the image scanning/accumulating system having the hardware configuration shown in FIG. 1D.

In the configuration shown in FIG. 41, the computer connected to the network NW, the scanner 3, and the touch panel 4 serves as the information issuing unit 1, and the database server connected to the network NW serves as the information managing unit 2. In this example, when a user logs on the computer, it can be considered that the user has been authenticated. Therefore, it is not necessary to provide the user authentication unit 14 shown in FIG. 2. Furthermore, instead of the direct touch on the button displayed on the touch panel 4, the user can click the button with a mouse (not shown) included in the computer. Or, for example, when the user inputs a user name, the user can input the user name with a keyboard (not shown) included in the computer instead of the software keyboard 35.

According to an aspect of the present invention, it is possible to accumulate electronic image data on a scanned paper-based document in association with task information and to notify other associated with the accumulated image data of the accumulation of the image data. Therefore, not only the user but also the others associated with the accumulated image data can immediately access to the image data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image scanning/accumulating system comprising:
an information issuing unit that acquires image data; and
an information managing unit that includes an image-data database for storing therein the image data acquired by the information issuing unit, and manages the image data, wherein
the information managing unit includes a task-information database, and manages task information stored in the task-information database, and
the information issuing unit includes
an image pickup unit that scans a paper-based document thereby obtaining image data, and registers the image data in the image-data database;
an information display unit that acquires task information from the task-information database to be associated with the image data obtained by the image pickup unit, and displays acquired task information on a task-information setting screen; and
a notifying unit that notifies a contact address included in the task information that the image data associated with the task information is registered in the image-data database.

2. The image scanning/accumulating system according to claim 1, wherein
the information display unit displays a contact-address selection screen where a user can select an arbitrary contact address included in the task information, and
the notifying unit notifies a contact address selected by the user via the contact-address selection screen that the image data associated with the task information is registered in the image-data database.

3. The image scanning/accumulating system according to claim 1, wherein the information issuing unit includes a first communication unit and the information managing unit includes a second communication unit, and the first communication unit and the second communication unit being connected via a network so as to be able to exchange information therebetween.

4. The image scanning/accumulating system according to claim 1, wherein the contact address is an electronic mail address.

5. The image scanning/accumulating system according to claim 1, wherein the task information is at least one selected from schedule information, ToDo information, project information, and user group information.

6. The image scanning/accumulating system according to claim 1, wherein the information display unit displays a user-information input screen where a user can input user information for identifying the user, and acquires task information associated with the user information input by the user via the user-information input screen from the task-information database.

7. The image scanning/accumulating system according to claim 1, wherein the information display unit displays a user-information selection screen where a user can select user information for identifying the user, and acquires task information associated with the user information selected by the user via the user-information selection screen from the task-information database.

8. The image scanning/accumulating system according to claim 1, wherein
the information managing unit includes a user-information database that contains at least password information indicative of password of a user, and manages the password information,
the information display unit displays a password input screen where a user can input a password, and
the information issuing unit includes a user authentication unit that verifies whether the password input by the user via the password input screen matches the password information acquired from the user-information database, and allows the user to use the image scanning/accumulating system if the user is authenticated by the user authentication unit.

9. An image scanning/accumulating method implemented in an image scanning/accumulating system that includes an information issuing unit that includes an image pickup unit capable of scanning a paper-based document thereby obtaining image data; and an information managing unit that includes an image-data database for storing therein the image data acquired by the information issuing unit and manages the image data, and a task-information database, and manages task information stored in the task-information database, the image scanning/accumulating method comprising:
the information issuing unit acquiring task information from the task-information database to be associated with the image data obtained by the image pickup unit, and displaying acquired task information on a task-information setting screen on an information display unit;
the information issuing unit causing the image pickup unit to scan a paper-based document thereby obtaining image data, and registering the image data in the image-data database of the information managing unit; and
a notifying unit of the information issuing unit notifying a contact address included in the task information that the image data associated with the task information is registered in the image-data database.

10. The image scanning/accumulating method according to claim 9, wherein
the information issuing unit displaying a contact-address selection screen on the information display unit where a user can select an arbitrary contact address included in the task information, and
the information issuing unit notifying a contact address selected by the user via the contact-address selection screen that the image data associated with the task information is registered in the image-data database.

11. The image scanning/accumulating method according to claim 9, wherein the information issuing unit displaying a user-information input screen on the information display unit where a user can input user information for identifying the user, and acquiring task information associated with the user information input by the user via the user-information input screen from the task-information database.

12. The image scanning/accumulating method according to claim 9, wherein the information issuing unit displaying a user-information selection screen on the information display unit where a user can select user information for identifying the user, and acquiring task information associated with the user information selected by the user via the user-information selection screen from the task-information database.

13. The image scanning/accumulating method according to claim 9, wherein
the information issuing unit displaying a password input screen on the information display unit where a user can input a password, and
a user authentication unit of the information issuing unit verifying whether the password input by the user via the password input screen matches password information acquired from the information managing unit, and allowing the user to use the image scanning/accumulating system if the user is authenticated.

14. A computer program product that includes a computer program stored on a computer-readable recording medium which when executed on a computer causes the computer to realize an image scanning/accumulating method implemented in an image scanning/accumulating system that includes an information issuing unit that includes an image pickup unit capable of scanning a paper-based document thereby obtaining image data; and an information managing unit that includes an image-data database for storing therein the image data acquired by the information issuing unit and manages the image data, and a task-information database, and manages task information stored in the task-information database, the computer program causing the computer to execute:
the information issuing unit acquiring task information from the task-information database to be associated with the image data obtained by the image pickup unit, and displaying acquired task information on a task-information setting screen on an information display unit;
the information issuing unit causing the image pickup unit to scan a paper-based document thereby obtaining image data, and registering the image data in the image-data database of the information managing unit; and
a notifying unit of the information issuing unit notifying a contact address included in the task information that the image data associated with the task information is registered in the image-data database.

15. The computer program product according to claim 14, wherein
the information issuing unit displaying a contact-address selection screen on the information display unit where a user can select an arbitrary contact address included in the task information, and
the information issuing unit notifying a contact address selected by the user via the contact-address selection screen that the image data associated with the task information is registered in the image-data database.

16. The computer program product according to claim 14, wherein the information issuing unit displaying a user-information input screen on the information display unit where a user can input user information for identifying the user, and acquiring task information associated with the user information input by the user via the user-information input screen from the task-information database.

17. The computer program product according to claim 14, wherein the information issuing unit displaying a user-information selection screen on the information display unit where a user can select user information for identifying the user, and acquiring task information associated with the user information selected by the user via the user-information selection screen from the task-information database.

18. The computer program product according to claim 14, wherein
the information issuing unit displaying a password input screen on the information display unit where a user can input a password, and
a user authentication unit of the information issuing unit verifying whether the password input by the user via the password input screen matches password information acquired from the information managing unit, and allowing the user to use the image scanning/accumulating system if the user is authenticated.
